(19) United States
(12) Patent Application Publication
(10) Pub. No.: US 2023/0128230 A1
(43) Pub. Date: Apr. 27, 2023

(54) ELASTIC HOT GLUE HAVING LOW PROCESSING TEMPERATURE CAPABILITY

(71) Applicant: SAN FANG CHEMICAL INDUSTRY CO., LTD., KAOHSIUNG CITY (TW)

(72) Inventors: CHIH-YI LIN, KAOHSIUNG CITY (TW); KUO-KUANG CHENG, KAOHSIUNG CITY (TW); CHI-CHIN CHIANG, KAOHSIUNG CITY (TW); WEN-HSIN TAI, KAOHSIUNG CITY (TW); SHENG HORNG GUO, KAOHSIUNG CITY (TW)

(21) Appl. No.: 18/047,575

(22) Filed: Oct. 18, 2022

(30) Foreign Application Priority Data
Oct. 22, 2021 (TW) 110139293

(51) Int. Cl. C09J 7/35; C09J 7/10

(52) U.S. Cl. CPC C09J 7/35; C09J 7/10; C09J 2301/304; C09J 2475/00

(57) ABSTRACT

The present disclosure relates to an elastic hot glue having low processing temperature capability. The elastic hot glue includes a TPU glue layer. The melting point of the TPU glue layer is 60˜100° C. The elastic recovery rate of the TPU glue layer is 95-100%. The elastic hot glue of the present disclosure can be widely applied to low processing temperature. The product using the elastic hot glue of the present disclosure has high elasticity recovery, and strong peeling strength so as to avoid the damage of the product, and increase the life of the product and maintain the appearance of the product.

### FIELD

The disclosure relates to an elastic hot glue having low processing temperature capability.

### BACKGROUND

Conventional hot glues are used for laminating products at high temperature (>130° C.), so that the peeling strength of the products can meet the industry application standard (>3000 cN). However, the excessively high processing temperature limits the application of the conventional hot glues, so that the conventional hot glues cannot be widely used for various products. For example, the current and conventional materials for ready-wear clothing are disadvantageous for lamination processing at excessively high temperature.

In addition, the conventional hot glues cannot be used for processing at low temperature and do not have high elasticity recovery. If the conventional hot glues are used in clothing products, it is desirable to consider what occasion the clothing products on customers are on, so as to avoid impact of high intensive exercise on the peeling strength of the clothing products and damage to the clothing products. Moreover, the conventional hot glues are prone to excessive melting during processing at high temperature (>130° C.), leading to a decrease in the peeling strength.

### SUMMARY OF THE INVENTION

In accordance with one aspect of the present disclosure, an elastic hot glue having low processing temperature capability includes a thermoplastic polyurethane (TPU) glue layer with a melting point of 60-100° C. and an elastic recovery rate of 95-100%.

In accordance with one aspect of the present disclosure, an elastic hot glue having low processing temperature capability includes a plurality of TPU glue layers. The TPU glue layers are stacked into the elastic hot glue. The TPU glue layers have a melting point of 80-120° C. and an elastic recovery rate of 97-100%.

### BRIEF DESCRIPTION OF THE DRAWINGS

Aspects of the present disclosure are understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic structural diagram of an elastic hot glue having low processing temperature capability according to an embodiment of the present disclosure.

FIG. 2 is a schematic structural diagram of an elastic hot glue having low processing temperature capability according to another embodiment of the present disclosure.

### DETAILED DESCRIPTION OF THE INVENTION

It is to be understood that the following disclosure provides many different embodiments or examples, for implementing different features of various embodiments. Specific examples of components and arrangements are described below to simplify the present disclosure. The present disclosure may, however, be embodied in many different forms and should not be construed as being limited to the embodiments set forth herein; rather, these embodiments are provided so that this description will be thorough and complete, and will fully convey the present disclosure to those of ordinary skill in the art. It will be apparent, however, that one or more embodiments may be practiced without these specific details.

In addition, the present disclosure may repeat reference numerals and/or letters in the various examples. This repetition is for the purpose of simplicity and clarity and does not in itself dictate a relationship between the various embodiments and/or configurations discussed.

It will be understood that when an element is referred to as being “on” another element, it can be directly on the other element or intervening elements may be present. In contrast, when an element is referred to as being “directly on” another element, there are no intervening elements present.

It will be understood that singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this disclosure belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

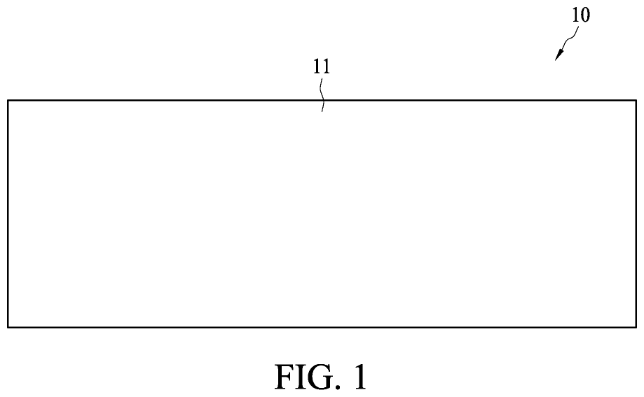

Referring to FIG. 1, it is a schematic structural diagram of an elastic hot glue having low processing temperature capability according to an embodiment of the present disclosure. In an embodiment, an elastic hot glue 10 having low processing temperature capability includes: a thermoplastic polyurethane (TPU) glue layer 11 with a melting point of 60-100° C. and an elastic recovery rate of 95-100%. That is, the elastic hot glue 10 has a melting point of 60-100° C. and an elastic recovery rate of 95-100%. In an embodiment, the elastic hot glue 10 having low processing temperature capability can be used for laminating clothes, but is not limited to the above.

In an embodiment, the test method and calculation formula of the elastic recovery rate are described as follows. Test method of elastic recovery rate: 1. Test piece specification (25.4 mm wide and 115 mm long), distance between the upper and lower clamps of 50 mm, and tensile speed of 500 mm/min, where the test piece is the elastic hot glue having low processing temperature capability in the present disclosure. 2. Recovery rate test: The test piece (25.4 mm wide and 115 mm long) between the upper and lower clamps with a distance of 50 mm is stretched at a tensile speed of 304 mm/min by 100% of its length and released immediately, and the change in length is measured after 1 min. The calculation formula of the elastic recovery rate: R_{g}=(L₁−L₂/L₁−L₀)*100%. R_{g}: Elastic recovery rate (%), L₀: Initial length of the test piece with no external force applied, L₁: Length of the test piece stretched by external force applied, and L₂: Length of the test piece after removing the external force for a certain period of time.

In an embodiment, the TPU glue layer 11 has a hardness of 40-80 A and a processing temperature used of 100-150° C. In an embodiment, the TPU glue layer 11 (the elastic hot glue 10) has a tensile strength of 40-180 kgf/cm². In an embodiment, the TPU glue layer 11 (the elastic hot glue 10) has an elongation of 800-1200%. In an embodiment, the TPU glue layer 11 (the elastic hot glue 10) has a thickness of 0.03-0.6 mm.

In an embodiment, after the elastic hot glue 10 having low processing temperature capability in the present disclosure is processed into a product within the hot-pressing temperature range, the product can still maintain strong peeling strength between 3000 cN and 6000 cN after more than 5, 15, or 25 cycles of washing and drying at 40° C. or 60° C.

In an embodiment, the elastic hot glue 10 having low processing temperature capability in the present disclosure can be widely used in low temperature processing, so that the product has high elastic recovery rate and strong peeling strength, to avoid damage to the product, prolong life of the product, and have a good appearance.

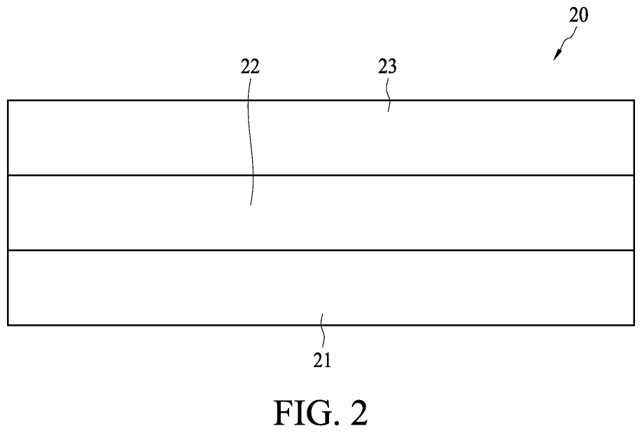

Referring to FIG. 2, it is a schematic structural diagram of an elastic hot glue having low processing temperature capability according to another embodiment of the present disclosure. In an embodiment, an elastic hot glue 20 having low processing temperature capability includes: a plurality of TPU glue layers 21, 22, and 23. The TPU glue layers are stacked into the elastic hot glue 20. The TPU glue layers have a melting point of 80-120° C. and an elastic recovery rate of 97-100%. In an embodiment, the elastic hot glue 20 has a hardness of 40-80 A and a processing temperature used of 100-150° C.

In an embodiment, the elastic hot glue 20 having low processing temperature capability includes: a first TPU glue layer 21, a second TPU glue layer 22, and a third TPU glue layer 23. In an embodiment, the elastic hot glue 20 has a tensile strength of 40-180 kgf/cm². In an embodiment, the elastic hot glue 20 has an elongation of 800-1200%. In an embodiment, the elastic hot glue 20 has a thickness of 0.03-0.6 mm.

In an embodiment, the first TPU glue layer 21 has a hardness of 60-70 A. The second TPU glue layer 22 has a hardness of 40-70 A. The third TPU glue layer has a hardness of 60-70 A. The first TPU glue layer 21 has a thickness of 0.01-0.2 mm. The second TPU glue layer 22 has a thickness of 0.01-0.2 mm. The third TPU glue layer 23 has a thickness of 0.01-0.2 mm. In an embodiment, the elastic hot glue 20 having low processing temperature capability in the present disclosure has a total thickness of 0.03-0.6 mm.

In an embodiment, the first TPU glue layer 21 and the third TPU glue layer 23 may be made of the same material and have the same hardness. In an embodiment, compared with the first TPU glue layer 21 or the third TPU glue layer 23, the second TPU glue layer 22 is soft and elastic. In an embodiment, compared with the first TPU glue layer 21 or the third TPU glue layer 23, the second TPU glue layer 22 has a high melting point. Therefore, the second TPU glue layer 22 is disposed between the first TPU glue layer 21 and the third TPU glue layer 23, so that the phenomenon of glue leakage during processing at high temperature can be reduced due to the difference in flow value, resulting in a wider processing temperature range used for the elastic hot glue 20 having low processing temperature capability in the present disclosure.

In an embodiment, the multi-layer structure allows the elastic hot glue 20 having low processing temperature capability in the present disclosure to have better physical properties, better peeling strength, and wider processing temperature range used.

### Embodiment 1

First TPU pellets with a hardness of 70 A, second TPU pellets with a hardness of 50 A, and third PU pellets with a hardness of 70 A were dried at 70° C. for 4 hours to control a water content below 300 ppm.

The first TPU pellets were fed into a first extruder with temperatures set to 145° C., 155° C., and 155° C. in sequence.

The second TPU pellets were fed into a second extruder with temperatures set to 165° C., 175° C., and 175° C. in sequence.

The third TPU pellets were fed into a third extruder with temperatures set to 145° C., 155° C., and 155° C. in sequence.

The temperature of the T-DIE head was set to 135° C. The flow ratio of a diverter was adjusted to 1:1:1, so that the first TPU glue layer 21, the second TPU glue layer 22, and the third TPU glue layer 23 can be extruded together from the die head with the same thickness.

The first TPU glue layer 21, the second TPU glue layer 22, and the third TPU glue layer 23 were cooled down to form a film by using a laminating roller with a speed controlled to 8 m/min, to obtain the elastic hot glue 20 having low processing temperature capability in the present disclosure with a total thickness of about 0.1 mm.

After testing, the physical properties of the elastic hot glue having low processing temperature capability in Embodiment 1 in the present disclosure are as follows.

| | Peeling strength | Peeling strength | Peeling strength |
|---|---|---|---|
| Processing | of product | of product | of product |
| temper- | before | washed for | washed for |
| ature/° C. | washing/cN | 5 cycles/cN | 25 cycles/cN |
| 120° C. | 4261 | 3637 | 3535 |
| 150° C. | 3101 | 3069 | 3005 |

| Specifi- | Tensile | | 100% | 300% | Elastic |
|---|---|---|---|---|---|
| cation | strength | | Modulus | Modulus | recovery |
| mm | kgf/cm² | Elongation % | kgf/cm² | kgf/cm² | rate % |
| 0.1 | 170 | 1060 | 15 | 17 | 97 |

### Embodiment 2

The TPU pellets with a hardness of 70 A were dried at 70° C. for 4 hours to control a water content below 300 ppm.

The TPU pellets were fed into an extruder with temperatures set to 150° C., 160° C., and 160° C. in sequence.

The temperature of the T-DIE head was set to 140° C. The TPU glue layer 11 can be extruded from the die head.

The first TPU glue layer 11 was cooled down to form a film by using a laminating roller with a speed controlled to 9 m/min, to obtain the elastic hot glue 10 having low processing temperature capability in the present disclosure with a total thickness of about 0.1 mm.

After testing, the physical properties of the elastic hot glue having low processing temperature capability in Embodiment 2 in the present disclosure are as follows.

| | Peeling strength | Peeling strength | Peeling strength |
|---|---|---|---|
| Processing | of product | of product | of product |
| temper- | before | washed for | washed for |
| ature/° C. | washing/cN | 5 cycles/cN | 25 cycles/cN |
| 120° C. | 3833 | 3481 | 3198 |

| Specifi- | Tensile | | 100% | 300% | Elastic |
|---|---|---|---|---|---|
| cation | strength | | Modulus | Modulus | recovery |
| mm | kgf/cm² | Elongation % | kgf/cm² | kgf/cm² | rate % |
| 0.1 | 160 | 960 | 15 | 30 | 95 |

### Compared Example 1

The TPU pellets with a hardness of 95 A were dried at 70° C. for 4 hours to control a water content below 300 ppm.

The TPU pellets were fed into an extruder with temperatures set to 160° C., 170° C., and 170° C. in sequence.

The temperature of the T-DIE head was set to 155° C. The TPU glue layer can be extruded from the die head.

The TPU glue layer was cooled down to form a film by using a laminating roller with a speed controlled to 9 m/min, to obtain the elastic hot glue with a total thickness of about 0.1 mm.

After testing, the physical properties of the elastic hot glue in Compared Example 1 are as follows. Apparently, the physical properties of the elastic hot glue in Compared Example 1 are worse than those of the elastic hot glue having low processing temperature capability in the above Embodiments in the present disclosure

| Specific- | Tensile | | 100% | 300% | Elastic |
|---|---|---|---|---|---|
| ation | strength | | Modulus | Modulus | recovery |
| mm | kgf/cm² | Elongation % | kgf/cm² | kgf/cm² | rate % |
| 0.1 | 145 | 680 | 38 | 48 | 80 |

### Compared Example 2

The TPU pellets with a hardness of 95 A were dried at 70° C. for 4 hours to control a water content below 300 ppm.

The TPU pellets were fed into an extruder with temperatures set to 180° C., 190° C., and 190° C. in sequence.

The temperature of the T-DIE head was set to 175° C. The TPU glue layer can be extruded from the die head.

The first TPU glue layer was cooled down to form a film by using a laminating roller with a speed controlled to 7 m/min, to obtain the elastic hot glue with a total thickness of about 0.1 mm.

After testing, the physical properties of the elastic hot glue in Compared Example 2 are as follows.

| | Peeling strength | Peeling strength | Peeling strength |
|---|---|---|---|
| Processing | of product | of product | of product |
| temper- | before | washed for | washed for |
| ature/° C. | washing/cN | 5 cycles/cN | 25 cycles/cN |
| 120° C. | 491 | X | X |

| Specifi- | Tensile | | 100% | 300% | Elastic |
|---|---|---|---|---|---|
| cation | strength | | Modulus | Modulus | recovery |
| mm | kgf/cm² | Elongation % | kgf/cm² | kgf/cm² | rate % |
| 0.1 | 158 | 900 | 20 | 25 | 85 |

Therefore, the elastic hot glue of the Compared Example 2 cannot be processed at low temperature.

Moreover, the scope of the present application is not intended to be limited to the particular embodiments of the process, machine, manufacture, and composition of matter, means, methods and steps described in the specification. As those skilled in the art will readily appreciate form the present disclosure, processes, machines, manufacture, compositions of matter, means, methods, or steps, presently existing or later to be developed, that perform substantially the same function or achieve substantially the same result as the corresponding embodiments described herein may be utilized in accordance with some embodiments of the present disclosure.

Accordingly, the appended claims are intended to include within their scope such processes, machines, manufacture, and compositions of matter, means, methods or steps. In addition, each claim constitutes a separate embodiment, and the combination of various claims and embodiments are within the scope of the disclosure.

What is claimed is:

1. An elastic hot glue having low processing temperature capability, comprising:
a thermoplastic polyurethane (TPU) glue layer with a melting point of 60-100° C. and an elastic recovery rate of 95-100%.

2. The elastic hot glue of claim 1, wherein the elastic hot glue has a processing temperature used of 100-150° C.

3. The elastic hot glue of claim 1, wherein the elastic hot glue has a hardness of 40-80 A.

4. The elastic hot glue of claim 1, wherein the elastic hot glue has a tensile strength of 40-180 kgf/cm².

5. The elastic hot glue of claim 1, wherein the elastic hot glue has an elongation of 800-1200%.

6. The elastic hot glue of claim 1, wherein the elastic hot glue has a thickness of 0.03-0.6 mm.

7. The elastic hot glue of claim 1, wherein the elastic hot glue has a peeling strength between 3000 cN and 6000 cN after 25 cycles of washing and drying at 60° C.

8. An elastic hot glue having low processing temperature capability, comprising:
a plurality of TPU glue layers, the TPU glue layers stacked into the elastic hot glue, the TPU glue layers having a melting point of 80-120° C. and an elastic recovery rate of 97-100%.

9. The elastic hot glue of claim 8, wherein the elastic hot glue has a processing temperature used of 100-150° C.

10. The elastic hot glue of claim 8, wherein the elastic hot glue has a hardness of 40-80 A.

11. The elastic hot glue of claim 8, wherein the elastic hot glue has a tensile strength of 40-180 kgf/cm².

12. The elastic hot glue of claim 8, wherein the elastic hot glue has an elongation of 800-1200%.

13. The elastic hot glue of claim 8, wherein the elastic hot glue has a thickness of 0.03-0.6 mm.

14. The elastic hot glue of claim 8, wherein the elastic hot glue has a peeling strength between 3000 cN and 6000 cN after 25 cycles of washing and drying at 60° C.
